(19) United States
(12) Patent Application Publication
(10) Pub. No.: US 2026/0247212 A1
(43) Pub. Date: Aug. 20, 2026

(54) METHOD AND DEVICE FOR PERFORMING DYNAMIC MTU CONVERSION FOR CELLULAR CORE NETWORK

(71) Applicants: Samsung Electronics Co., Ltd., Gyeonggi-do (KR); KOREA ADVANCED INSTITUTE OF SCIENCE AND TECHNOLOGY, Daejeon-si (KR)

(72) Inventors: Youngmin CHOI, Daejeon-si (KR); Kyoungsoo PARK, Daejeon-si (KR); Junghan YOON, Daejeon-si (KR)

(21) Appl. No.: 19/160,974

(22) PCT Filed: Mar. 8, 2024
(86) PCT No.: PCT/KR2024/003033

§ 371 Date: Aug. 29, 2025

(30) Foreign Application Priority Data
Mar. 16, 2023 (KR) 10-2023-0034671
Nov. 13, 2023 (KR) 10-2023-0156081

(51) Int. Cl. H04W 28/06; H04L 47/36; H04W 28/18

(52) U.S. Cl. CPC H04W 28/06; H04L 47/36; H04W 28/18

(57) ABSTRACT

The present disclosure relates to a 5G or 6G communication system for supporting higher data transmission rates. Disclosed is a method performed by a UPF in a wireless communication system. The method may comprise the steps of: receiving a plurality of first size packets from a packet data network (PDN); merging at least a portion of the plurality of first size packets received from the PDN and converting the merged packets into second size packets; performing lookup on packet processing rules for one or more of the second size packets and performing packet processing according to the lookup result; dividing the packet-processed second size packets into a plurality of third size packets; and transmitting the third size packets to a user terminal.

### TECHNICAL FIELD

The disclosure relates to a method and a device for dynamically converting a maximum transmission unit (MTU) for a cellular core network, and proposes a method for more efficiently processing a large amount of traffic by dynamically changing the size of the MTU.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

A maximum transmission unit (MTU) refers to the maximum size of a packet that can be included in and transmitted as a single packet in a specific IP network. Among link layer technologies constituting an IP network, Ethernet is most commonly used, and a maximum frame size (MFS) most commonly used in the Ethernet is 1518 bytes (including 18 bytes of Ethernet header+FCS), and thus a 1500-byte MTU is mainly used in the most wide-area network (WAN) environment.

Recent network devices support an MTU equal to or greater than 1500 bytes, such as jumbo frames (9000 bytes), but in an actual network environment on the Internet, an MTU of 1500 bytes is still mainly used. This is to prevent degradation of packet processing performance of a public data network (PDU) due to IP fragmentation performed in the router when a packet larger than an MTU size of a transmission link is processed. Accordingly, both a wireless communication network and a user equipment (UE) use an MTU less than 1500 bytes.

However, 1500 bytes correspond to an MTU size adopted in a 10 Mbps speed shared Ethernet, and thus in a current situation in which switched Ethernet is widely used and a bandwidth gets larger, there are not man reasons to use a 1500-byte MTU.

Recently, a network bandwidth has been rapidly increasing as a network card supporting 400 Gbps speed emerges and a commercial switch capable of handling tens to Tbps is released. However, a performance improvement rate of a central processing unit (CPU) is slower than before and a bottleneck is caused at a CPU level other than a network bandwidth in a network application.

### DISCLOSURE

### Technical Problem

An aspect of the disclosure is to dynamically adjust an MTU size used in a PDN and an MTU size used within a wireless communication network so as to reduce a computation load required for packet processing within a core network and improve a packet processing rate of a wireless network and a user equipment.

### Technical Solution

An embodiment of the disclosure may provide a method performed by a user plane function (UPF) in a wireless communication system. The method including receiving multiple first size packets from a packet data network (PDN), merging and converting at least some of the multiple first size packets, received from the PDN, into second size packets, performing lookup on packet processing rules for one or more of the second size packets and performing packet processing according to a result of the lookup, dividing the packet-processed second size packets into multiple third size packets, and transmitting the third size packets to a user terminal.

According to an embodiment, the merging and converting of the at least some of the multiple first size packets into second size packets may include performing primary merging for first packets through a large receive offload (LRO) function corresponding to a hardware function of the UPF, and performing secondary merging for the first packets through a generic receive offload (GRO) function corresponding to a software function of the UPF.

An algorithm for the GRO function may include searching for a flow to which packets to be merged belong through a 5-tuple-based hash table.

An algorithm for the GRO function may include determining a bucket where a flow to which packets to be merged belong exists through a receive-side scaling (RSS) hash value.

The method of the UPF may further include allocating, based on a maximum number of RX queues supported by the UPF, multiple RX queues to at least some CPU cores among CPU cores of the UPF, and distributing flows, received from the PDN, to the multiple RX queues.

The first size packets may be configured to have a 1500-byte size, and the third size packets may be configured to have a 9000-byte size.

The method of the UPF may further include modifying a TCP maximum segment size (MSS) value of a TCP synchronization (SYN) packet, transmitted from the terminal to the PDN, as an MTU value of the PDN, and modifying a TCP MSS value of a TCP SYN packet, transmitted from the PDN to the terminal, as an MTU value of the terminal.

Another embodiment of the disclosure may provide a UPF operating in a wireless communication system. The UPF may include a transceiver and controller, and the controller may be configured to receive multiple first size packets from a packet data network (PDN), merge and convert at least some of the multiple first size packets, received from the PDN, into second size packets, perform lookup on packet processing rules for one or more of the second size packets and perform packet processing according to a result of the lookup, divide the packet-processed second size packets into multiple third size packets, and transmit the third size packets to a user terminal.

### Advantageous Effects

According to one of various embodiments of the disclosure, a UPF dynamically converts an MTU between a PDN and a core network, the MTU between the UPF and the PDN may be configured as a previously used 1500-byte size, and an MTU between the UPF and the core network may be configured as a 9000-byte size. Lookup on a rule such as a forwarding action rule (FAR), a buffering action rule (BAR), a QoS enforcement rule (QER), a packet detection rule (PDR), and a usage reporting rule (URR) performed by the UPF is performed using only header information of a packet, and when packets belonging to the same flow are converted into one large-size packet through dynamic MTU conversion proposed in the disclosure, a total number of packets are reduced and the number of rule lookup operations is also reduced, whereby the performance of the UPF can be improved.

According to one among various embodiments of the disclosure, more RX queues are allocated than before for each CPU core of a UPF, and thus the number of flows processed in each RX queue can be reduced. Accordingly, more packets can be merged through large receive offload (LRO) or generic receive offload (GRO), an average packet size can be increased, and a total number of packets is reduced, whereby the performance of the UPF can be improved.

According to one among various embodiments of the disclosure, by using a hash table-based GRO algorithm, the performance of the UPF can be improved compared to a case where a GRO algorithm using a linear search method is used.

### DESCRIPTION OF DRAWINGS

FIG. 1 simply illustrates a structure of a cellular network according to an embodiment of the disclosure.

FIG. 2 illustrates a process in which a UPF operates in the conventional art related to the disclosure.

FIG. 3 illustrates a process in which a UPF to which the technology according to an embodiment of the disclosure is applied operates.

FIG. 4 illustrates a method for enhancing the efficiency of LRO and GRO according to an embodiment of the disclosure.

FIG. 5 illustrates a method for improving a GRO algorithm disclosed according to an embodiment of the disclosure.

FIGS. 6A and 6B are flowcharts illustrating a method in which a UPF merges packets according to a GRO function according to an embodiment of the disclosure.

FIG. 7 is a flowchart illustrating a method in which a UPF performs processing for items included in a bucket queue according to a GRO function according to an embodiment of the disclosure.

FIG. 8 illustrates a structure of a UE according to an embodiment of the disclosure.

FIG. 9 illustrates a structure of a network entity according to an embodiment of the disclosure.

### MODE FOR INVENTION

In describing embodiments set forth herein, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Hereinafter, the operation principle of the disclosure will be described in detail in conjunction with the accompanying drawings. In describing the disclosure below, a detailed description of relevant known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

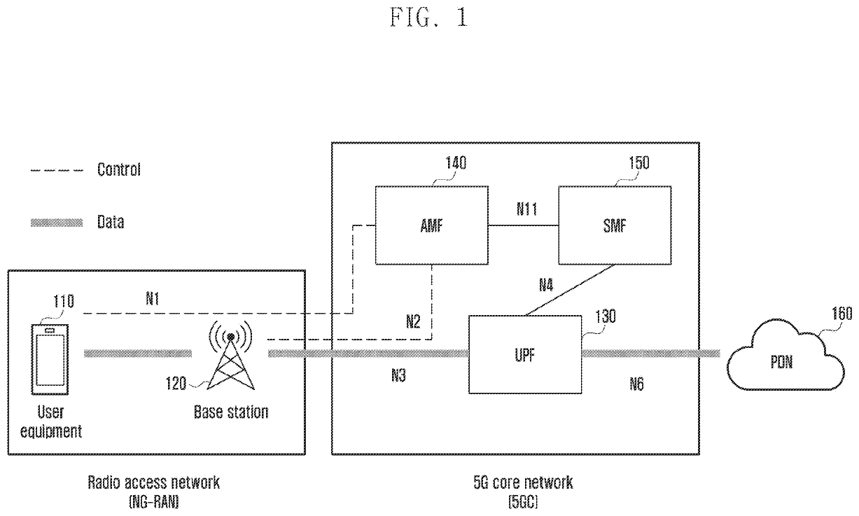

FIG. 1 simply illustrates a structure of a cellular network according to an embodiment of the disclosure.

Referring to FIG. 1, a cellular network may include a radio access network (NG-RAN), a 5G core (5GC) network, and a public data network (PDN). A user equipment (UE) 110 may wirelessly exchange user plane and control plane data with a base station (gNodeB or eNodeB) 120.

The function of the 5GC network may be classified into user plane and control plane. The control plane may include a network entity such as an access and mobility management function (AMF) 140 responsible for network access and mobility of the UE 110 and a session management function (SMF) 150 responsible for a session between the UE and a data network, and the user plane may include a network such as a user plane function (UPF) 130. The modern wireless network functions use a commercial server (commercial-off-the-shelf (COTS)), and thus it is important to enhance the performance of each COTS server to configure a wide-bandwidth cellular core network.

The UPF 130 may receive a rule related to packet processing from one SMF 150 among core elements of the cellular core network, and may perform a role of routing and transmitting packets between the base station 120 and a PDN 160. The UPF 130 may route and transmit packets between the base station 120 and the PDN 160 through rules such as a packet detection rule (PDR), a QoS enforcement rule (QER), a forward action rule (FAR), a buffering action rule (BAR), and a usage reporting rule (URR). A rule lookup operation corresponding to an operation in which the UPF 130 queries such rules through the SMF requires only header information of a packet, and payload information is not utilized for rule lookup.

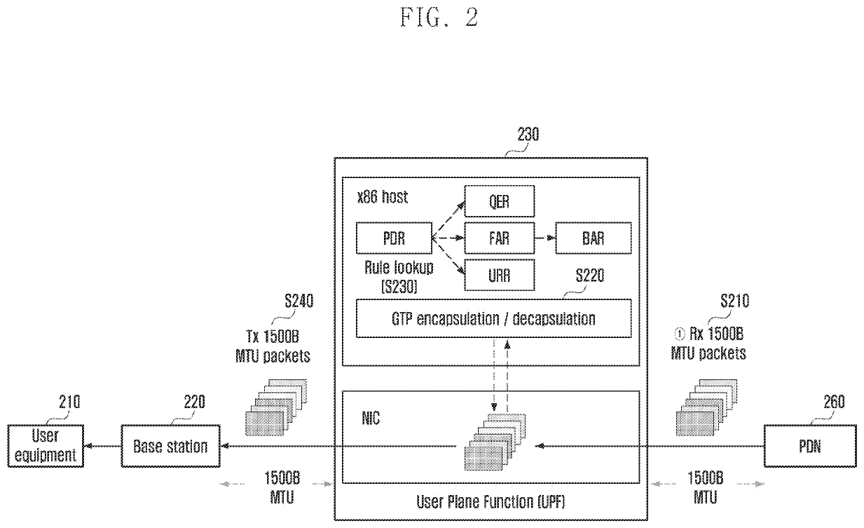

FIG. 2 illustrates a process in which a UPF operates in the conventional art related to the disclosure.

Referring to FIG. 2, conventionally, in the entire process in which a UPF 230 in the 5GC receives a packet from a PDN 260, performs processing for the packet, and transfers the processed packet to a UE 210 through a base station 220, or in the opposite process, the size of a maximum transmission unit (MTU) was fixed and the same size-packet was utilized. For example, a 1500-byte MTU was used in the wireless network, the 5GC network, and the PDN 260.

That is, when a network interface card (NIC) in the UPF 230 receives a 1500-byte packet from the PDN 260 (S210) and transfers the same to a CPU in the UPF 230, the CPU may perform CTP encapsulation and decapsulation for the corresponding packet (S220), and may perform lookup on the rules such as the PDR, QER, FAR, BAR, and URR (S230). Thereafter, the UPF 230 may perform, based on the rule identified through the lookup, processing for the packet, and transfer the same to the base station 220 (S240).

FIG. 2 illustrates that the sequence of the operations follows receiving a packet from the PDN 260 by the UPF 230 and processing the same, and then transferring the processed packet to the UE 210 through the base station 220, but unlike this, the UPF 230 may receive a packet from the UE 210, process the same, and then transfer the processed packet to the PDN 260.

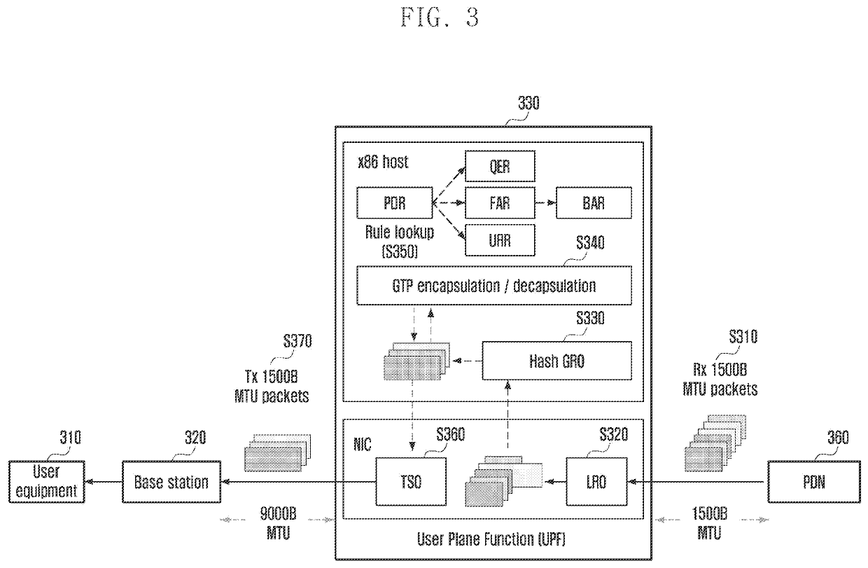

FIG. 3 illustrates a process in which a UPF to which the technology according to an embodiment of the disclosure is applied operates.

According to an embodiment, a UPF 330 illustrated in FIG. 3 may include a PDU session anchor (PSA) UPF.

Referring to FIG. 3, the UPF 330 may receive a 1500-byte packet (S310). Such an operation may be performed by an NIC included in the UPF 330.

The NIC included in the UPF 330 may merge packets belonging to the same TCP flow and having consecutive TCP sequence numbers into a single packet through a hardware function such as a large receive offload (LRO) (S320) and then transfer the merged packet to the CPU of the UPF 330 through direct memory access (DMA).

The LRO, as a hardware offload function provided in the commercial NIC, is a function enabling a receiver to merge packets belonging to the same TCP flow and having consecutive TCP sequence numbers into one large TCP packet and receive the merged packet. Through the function such as the LRO, DMA efficiency between a host and the NIC can be enhanced, and overhead per packet can be reduced as TCP/IP header processing performed in a network stack is reduced. In addition, the LRO is processed at the hardware end of the NCI, and thus it is advantageous that a CPU resource of the host is not used.

The CPU of the UPF 330 may receive the packets primarily merged through the LRO from the NIC through the DMA, and secondarily merge packets belonging to the same TCP flow in one packet batch and having consecutive TCP sequence numbers through generic receive offload (GRO) corresponding to a software function (S330). According to an embodiment, the GRO may merge the packets into a maximum of 64 KB size.

The GRO, as a software function provided by an NIC driver, is a function enabling packets belonging to the same flow and having consecutive TCP sequence numbers to be merged into one large TCP packet and received, with respect to packets received during a predetermined time interval or received in one batch. Through the GRO function, overhead per packet can be reduced as TCP/IP header processing is reduced. The LRO enables packet merging only for packets arriving consecutively, but the GRO enables merging for packets received for a predetermined time interval or received in one batch, and thus enables merging more packets. However, unlike the LRO, the GRO is a function performed on software, and thus it is disadvantageous that a CPU resource of the host is used.

Thereafter, the CPU of the UPF 330 may perform GTP encapsulation or decapsulation for the packets merged through the LRO and the GRO (S340), and perform lookup on rules such as the PDR, QER, FAR, BAR, and URR (S350). Thereafter, the UPF 330 may perform, based on the rule identified through the lookup, processing for the packet.

After operation S350, the NIC of the UPF 330 may segment, through a hardware function such as TCP segmentation offload (TSO), the merged packets into packets having a specific MTU size (e.g., 9000 bytes) (S360). According to an embodiment of the disclosure, the segmented size may be determined based on the MTU size supported by a UE 310.

The UPF 330 may transmit the packets having the specific MTU size, segmented in operation S360, to the UE 310 through a base station 320 (S370).

According to an embodiment of the disclosure, for configuration in which the UE 310 and the PDN 360 use MTUs having a 9000-byte size and a 1500-byte size, respectively, the UPF 330 may modify a value of a TCP maximum segment size (MSS) option of a TCP synchronization (SYN) packet transferred from the UE 310 to the PDN 360 to an MTU value (e.g., 1460) of the PDN 360, and may modify the value of the TCP MASS option of the TCP SYN packet transferred from the PDN 360 to the UE 310 to the MTU value (e.g., 8960) of the UE 310.

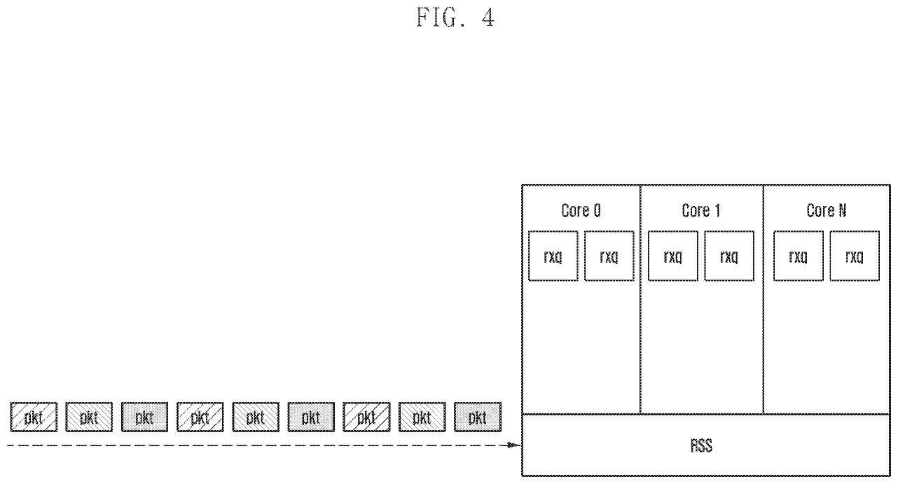

FIG. 4 illustrates a method for enhancing the efficiency of LRO and GRO according to an embodiment of the disclosure.

Referring to FIG. 4, the disclosure proposes a method for increasing the number of RX queues to enhance the efficiency of LRO and GRO.

In the conventional UPF, one RX queue per core of a CPU included in the UPF was allocated and the flow was distributed into multiple cores through receive-side scaling (RSS).

The RSS is a function of determining, when a packet such as a network entity is received, an RX queue in which the received packet is to be processed, based on 5-tuple information (source IP, destination IP, source port number, destination port number, and protocol ID) of the packet, and specifically, an RSS hash value may be generated based on the 5-tuple information, and processing for the packet may be performed based on the generated RSS hash value. When the RSS is used, flow-to-CPU core affinity can be secured and packets belonging to the respective flows can be processed in the same CPU core.

When the number of flows processed in the UPF, the number of flows coming into the RX queue allocated for each core of the CPU is also increased accordingly. The larger the number of flows processed in each RX queue, the lower the efficiency of the LRO and GRO functions.

Accordingly, an embodiment of the disclosure proposes a method for enhancing the efficiency of the LRO and GRO functions by increasing the number of RX queues allocated to each core included in the CPU of the UPF and reducing the number of flows processed in the individual RX queue.

According to an embodiment of the disclosure, a total number of RX queues may be configured, based on a maximum number of RX queues supported by the NIC of the UPF, not to exceed a maximum number of RX queues supported by the NIC of the UPF. Accordingly, multiple RX queues may be allocated to some or all of the CPU cores of the UPF. Thereafter, the UPF may distribute the TCP flow received from the PDN to the multiple RX queues.

According to an embodiment of the disclosure, compared to the conventional art, each core included in the CPU of the UPF can be allocated with more RX queues, thus the number of flows allocated to each RX queue can be reduced and the efficiency of the LRO and GRO functions can be enhanced.

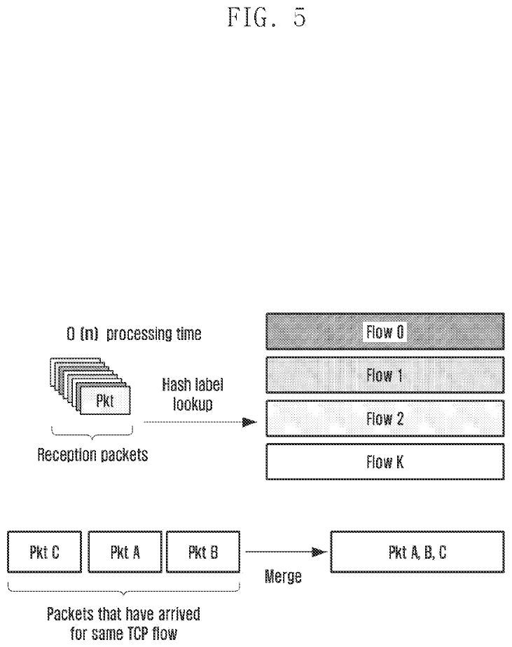

FIG. 5 illustrates a method for improving a GRO algorithm disclosed according to an embodiment of the disclosure.

A UPF may processing packets by merging the same for each flow through GRO, and such a processing method can be helpful for improving an operation efficiency of the entire cellular network and the UPF. However, the GRO operation uses a CPU cycle of the UPF, and thus there is necessity that overhead caused by the GRO is to be minimized. Accordingly, the inefficiency caused in the process of merging the packets through the GRO needs to be improved.

The GRO algorithm in the conventional art operated using linear search, and thus the following inefficiencies existed. For example, the GRO algorithm in the conventional art was able to be provided through a data plane development kit (DPDK) library.
1) By configuring a flow table as a linked list, the linear search was performed to search for a flow to which each reception packet belongs. That is, when the UPF receives n packets belonging to k flows, a cost of O (kn) is required to perform the linear search of the flow table.
2) In the case of the liner search, only one packet group that is consecutive to a reception packet is found in the found flow, it was disadvantageous that not all out-of-order packets can be merged. For example, when packets are received in the sequence of C-A-B, the merging can be performed in the form of (BC) and (A). Even in a case where packet A was able to be merged together, only some packets were merged, and thus the inefficiency existed.

Referring to FIG. 5, the improved GRO algorithm proposed in the disclosure may perform flow search to which a packet belongs through a 5-tuple-based hash table. The 5-tuple is a data format for communication, and may include a source IP, a destination IP, a source port number, a destination port number, and a protocol ID.

The improved GRO algorithm proposed in the disclosure may operate in the following methods.
1) In performing flow search, the UPF generates a 5-tuple-based hash table and performs search with a cost of O(n) by using the generated hash table.
2) The UPF may search for up to two packets that are consecutive in the flow to merge more out-of-order packets. For example, there may be up to two packets that are consecutive to one received TCP packet. According to the GRO algorithm proposed in the disclosure, when packets are received in the sequence of C-A-B, C is prioritized to be merged with B that is consecutive to C, which results in (BC) and (A), and B and A are additionally merged so that packets can be merged in the form of (ABC).
3) When the NIC of the UPF provides an RSS hash value as hardware, the UPF may reuse the RSS hash value for hash table search so as to remove the overhead required for hash operation. Unlike this, when the NIC does not provide the RSS hash value or a packet is distributed to each RX queue in a scheme other than the inner 5-tuple-based RSS, the UPF may calculate and use the RSS hash value based on the inner 5-tuple of the packet through software-based operation. The inner 5-tuple is a concept distinguished from the outer 5-tuple for an outer header which can be newly generated when a packet is encapsulated in another protocol.

In an embodiment of the disclosure, in order for the NIC of the UPF to evenly distribute packets to cores of the CPU, respectively, a hardware-based RSS hash value (Toeplitz hash value). In this case, the UPF may configure the NIC to record the corresponding RSS hash value to metadata of the packet through a hardware driver and provide the same to the software side. By default, RSS generates a hash value by using the inner 5-tuple as a key, but fields included in each header up to inner L4 may be configured to be used as the key for hash value generation.

Thereafter, the NIC of the UPF may distribute packets to several RX queues through the RSS and perform packet merging by using an LRO function on the hardware in each RX queue. Then, a GRO module may read multiple packets in a batch through a single RX I/O operation and additionally perform packet merging through the GRO algorithm. In this case, the RSS hash value may be included in the metadata of each packet.

According to another embodiment of the disclosure, the UPF may not use the inner 5-tuple as an RSS input value according to a specific purpose. In this case, a hash value may be fixed based on a smaller number of fields, and accordingly, a conflict can be frequently generated in the hash table, and thus the flows may not be evenly distributed through the RSS. In this case, the UPF may receive packets through the GRO module and use a software-computed hash value without using the hash value through RSS.

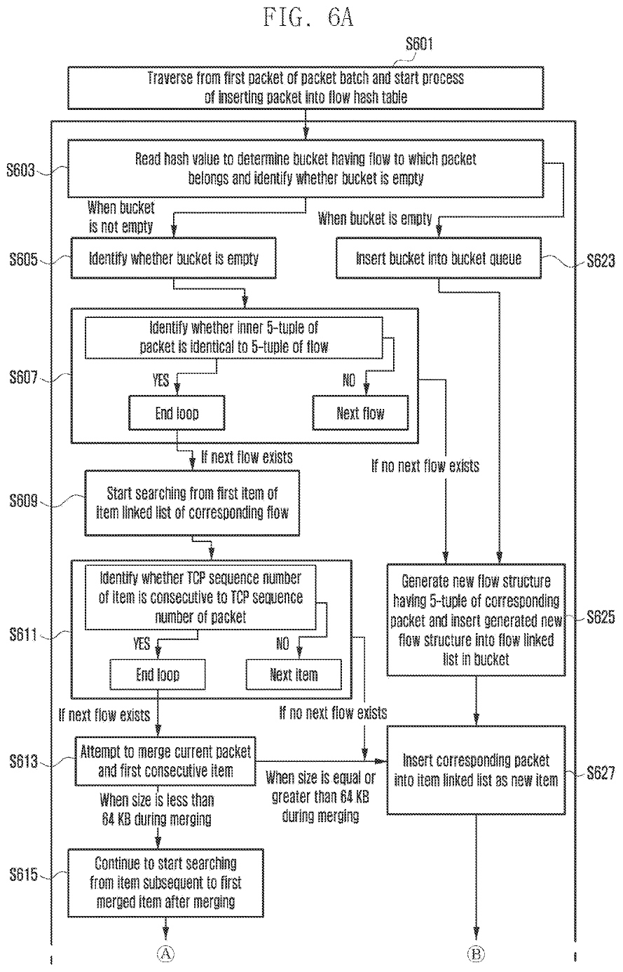

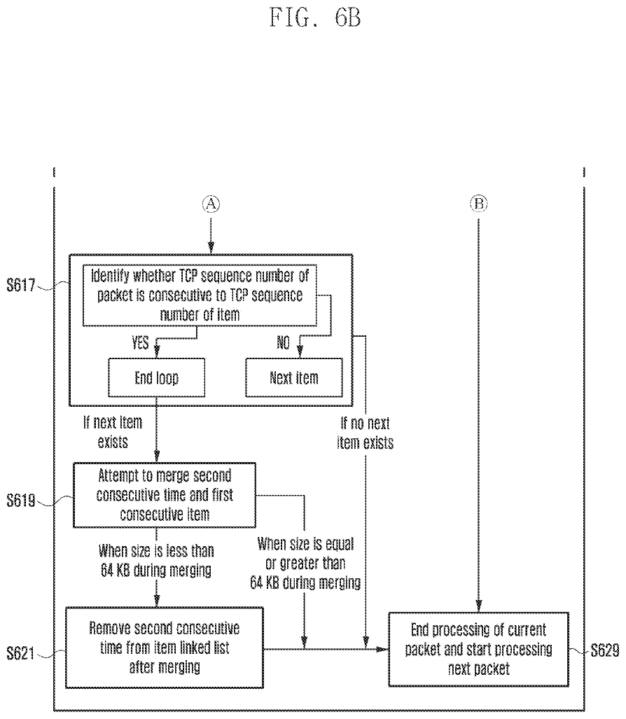

FIG. 6 is a flowchart illustrating a method in which a UPF merges packets according to a GRO function according to an embodiment of the disclosure.

Referring to FIGS. 6A and 6B, a GRO module using a hash table proposed in the disclosure may search a first packet included in a specific batch and start a process of inserting a flow hash table into the packet (S601).

Thereafter, the UPF may identify a hash value, determine a bucket having a flow to which the packet belongs, and identify whether the determined bucket is empty (S603). In this case, as described above, the used hash value may be a hash value generated through RSS by using inner 5-tuple, and unlike this, the used hash value may be a software-computed hash value through the GRO module after receiving the packet.

When the bucket identified in operation S603 is empty, operation S623 may be performed by the UPF, and in operation S623, the corresponding bucket may be inserted into a bucket queue storing a bucket that is not empty. This may be for querying the corresponding bucket when the flush operation is performed.

When the bucket identified in operation S603 is not empty, the search may be performed from the first flow of the bucket in operation S605. In the corresponding bucket, a hash conflict may occur, there may be a linked link including flows inserted into the same bucket, and accordingly, the UPF may search a flow to which the packet belongs from the first flow.

Specifically, in operation S607, the UPF may identify whether the inner 5-tuple of the received packet is identical to the 5-tuple of the flow found in the bucket, and when the inner 5-tuple is not identical to the 5-tuple, may compare the inner 5-tuple with 5-tuple of the next flow. When the inner 5-tuple of the packet received by the UPF is identical to the 5-tuple of the flow found in the bucket, the loop ends in operation S607, operation S609 may be performed, and when there is no flow having the same 5-tuple as the inner 5-tuple of the received packet as a result of identification of all flows in the corresponding bucket, operation S625 may be performed.

Operation S609 is a case where there is a flow to which the received packet in the bucket belongs, and the UPF may start searching from the first item of the item lined list of the flow.

The item in the disclosure may mean merging packets having consecutive TCP sequence numbers. When the packets are not consecutive or exceed 64 KB, the packets may be inserted into the item linked list of the flow as a new item.

In operation S611, the UPF may search the linked list of items belonging to the corresponding flow and identify whether there is an item that is consecutive to the TCP sequence number of the packet. When the item is not consecutive to the sequence number, whether the next item is consecutive to the TCP sequence number of the packet is continuously identified, and when an item having a TCP sequence number that is consecutive to the TCP sequence number of the packet is found, the loop ends in operation S611 and operation S613 may be performed. Unlike this, when it is identified that there is no item that is consecutive to the TCP sequence number of the packet in operation S611, operation S627 may be performed.

In operation S613, when the packet is merged with an item that is consecutive to the TCP sequence number of the packet, whether the size (the length of the TCP packet after the merging) of the item during the merging is less than 64 KB or is equal or greater than 64 KB. When the size of the item after the merging is less than 64 KB, operation S615 may be performed, and when the size is equal to or greater than 64 KB, operation S627 may be performed.

In operation S615, in order to merge the packet with the item and search whether there is an item that is consecutive to the merged item, the UPF may continue to perform searching from the next item of the corresponding item.

When there is another consecutive item exists in operation S617, operation S619 may be performed, and when there is no other consecutive time exists, the UPF may proceed to operation S629, the processing of the current packet ends, and processing of the next packet may be performed.

In operation S619, a merging attempt to the second item that is consecutive to the TCP sequence number of the packet may be performed, when the item size after the merging is less than 64 KB, operation S621 may be performed, and when the item size after merging is equal to or greater than 64 KB, the UPF may proceed to operation S629, the processing of the current packet ends, and processing of the next packet may be performed.

In operation S621, the UPF may merge the second item with the first item, and then remove the second item from the item linked list.

Operation S625 may be an operation subsequent to operation S607 or S623, and in operation S625, the UPF may generate a new flow structure having the 5-tuple of the received packet, and insert the generated new flow structure into the flow linked list in the bucket.

Operation S627 is a case where there is no item available to be merged with the current packet in the item linked list in the flow, or a case where there is an item but the size during the merging is equal to or greater than 64 KB, and in operation S627, the UPF may insert the current packet into the item linked list as a new item.

Thereafter, in operation S629, the UPF may start processing of the next packet after terminating the processing of the current packet. The processing of the next packet may be performed in the same manner as according to operations S601 to S627 illustrated in FIG. 6.

According to an embodiment of the disclosure, the disclosure is applicable to the processing of the TCP packet, and accordingly, the UPF may perform merging of packets through the LRO and GRO, but the disclosure is also applicable to processing of a UDP packet.

According to an embodiment, unlike the TCP packet, the UDP packet does not include a sequence number in the header, and thus merging multiple UDP packets into one large-size UDP packet may be impossible.

Accordingly, the disclosure proposes a method for simply bundling multiple UDP packets into one large IP packet and configuring the same in the form of a UDP packet caravan, a UPF proposed in the disclosure according thereto may process a linked UDP packet caravan as a single packet, whereby packet processing efficiency of the UPF in the environment in which the UDP packet is used can be increased.

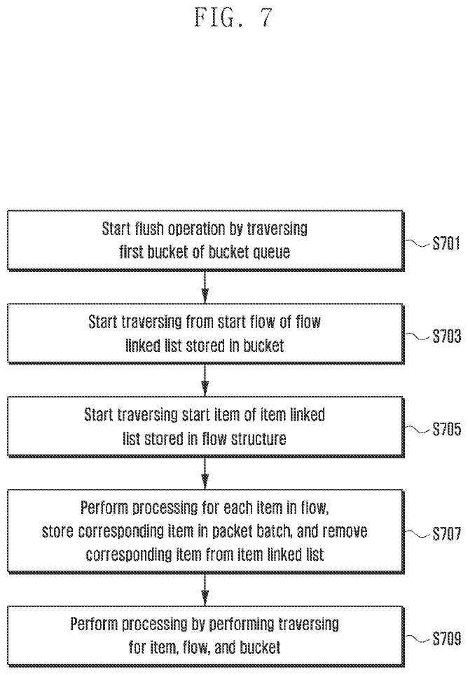

FIG. 7 is a flowchart illustrating a method in which a UPF performs processing for items included in a bucket queue according to a GRO function according to an embodiment of the disclosure.

Referring to FIG. 7, a UPF may perform an operation described below through a GRO module, and the operation of FIG. 7 may be performed in connection with the packet merging operation described through FIG. 6.

In operation S701, the UPF may perform traversing starting from a flush operation by starting from a first bucket of a bucket queue.

In operation S703, the UPF may start traversing from a start flow of a flow linked list stored in the bucket, and in operation S705, the UPF may start traversing starting from a start item of an item linked list stored in a flow structure.

In operation S707, the UPF may perform traversing in the sequence described in operations S703 and S705, and perform processing for each item in the flow. Specifically, in operation S707, the UPF may identify whether each item in the flow is an item obtained by merging two or more packets, and when a specific item is an item obtained by merging two or more packets, the UPF may modify a packet length field of an IP header. In operation S707, whether each item is an item obtained by merging two or more packets is identified, and after the processing according thereto, the corresponding item may be stored in a packet batch, and the corresponding item may be removed from an item linked list.

In operation S709, the UPF may perform the above-described operation by performing traversing for the item, flow, and bucket. That is, after processing for all items stored in one flow structure is completed, processing for items stored in the next flow structure is performed, and in the same method, after processing for all flow structures in one bucket is completed, the operation may move to the next bucket, and a flush operation may be performed until the processing for all buckets is performed.

According to an embodiment of the disclosure, all data structures used in operations S701 to S709 may be configured as arrays having the same size as a packet batch size so that the structures can be loaded into the cache at once. References between data structures (e.g., a link between flows in the flow linked list, a link between items in the item linked list, a link from a flow to the first item in its item list, a link from a bucket to the first flow in the flow list, or the like) may be performed using index numbers within the arrays.

According to an embodiment of the disclosure, after all the flush operation is performed, a bucket queue, a flow linked list of each bucket, and an item linked list of each flow are all empty, accordingly, empty data structures may be reused when a next packet batch is received. In addition, all data structures exist for each RX queue, and may not affect each other even GRO is performed in another RX queue.

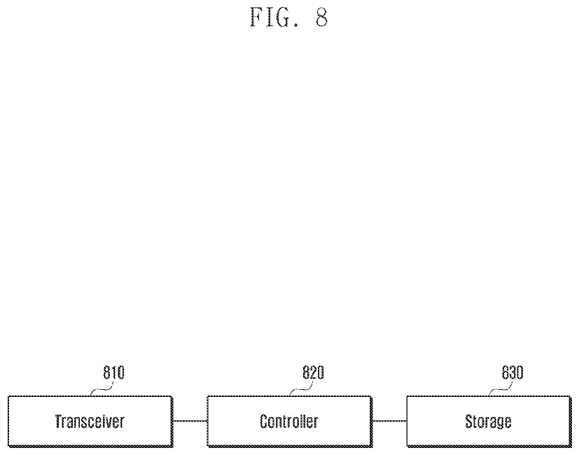

FIG. 8 illustrates a structure of a UE according to an embodiment of the disclosure.

Referring to FIG. 8, the UE may include a transceiver 810, a controller 820, and a storage 830. As used herein, the controller may be defined as a circuit, an application specific integrated circuit, or at least one processor.

The transceiver 810 may transmit/receive signals with other network entities. The transceiver 810 may receive, for example, system information, synchronization signals, or reference signals from the base station.

The controller 820 may control the overall operation of the UE according to the embodiments proposed in the disclosure. The controller 820 may control the overall operation of the UE according to the embodiments proposed in the disclosure. For example, the controller 820 may control the UE or terminal to generate a request for a PDU session and transmit the same to an AMF.

The storage 830 may store at least one of information transmitted/received through the transceiver 810 and information generated through the controller 820. For example, the storage 830 may store information related to a PDU session and various data received from a PDN.

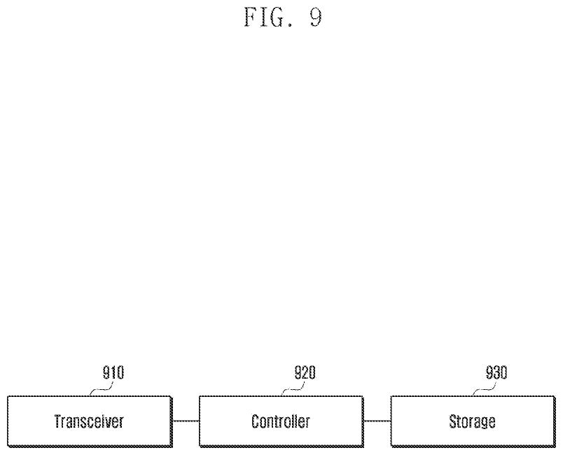

FIG. 9 illustrates a structure of a network entity according to an embodiment of the disclosure. The network entity may include an AMF, an UPF, an SMF, a PCF, a UDR, a UDM, an NEF, an AF, or the like.

The transceiver 910 may transmit/receive signals with other network entities. The transceiver 910 may transmit/receive, for example, PDU session-related information to UEs.

The controller 920 may control the overall operation of the network entities according to the embodiments proposed in the disclosure. For example, the controller 920 may control signal flows between the respective blocks to perform operations according to the above-described flowcharts. For example, the controller 920 may control the UPF to perform an operation of merging packets through a GRO module.

The storage 930 may store at least one of information transmitted/received through the transceiver 910 and information generated through the controller 920. For example, the storage 930 may store information on a GRO algorithm, information on a method of allocating a flow to an RX queue, information on received packets, and the like.

According to the above-described embodiment of the disclosure, by utilizing a dynamic MTU conversion technology, packets belonging to the same flow are converted into one large packet and processed, the number of rule lookup operations performed in the UPF can be reduced, and accordingly, the performance of the UPF can be improved. According to an experiment result, when the same number of CPU cores are used, it is identified that the UPF to which dynamic MTU conversion technology is applied shows a throughput improvement of 3.1 to 4.9 times compared to the conventional UPF.

According to the above-described embodiment of the disclosure, as more RX queues are allocated to each core of a CPU included in a UPF, the number of flows processed in each RX queue is reduced, and thus more packets can be merged through LRO or GRO. When more packets are merged and an average packet size is thus increased, a total number of rule lookup operations performed by the UPF can be reduced, and accordingly, the performance of the UPF can be improved. According to an experiment result, when the number of RX queues for each CPU core is increased to six, the average packet size after processing through LRO and GRO increased by 1.6 times to 13 KB, and it is identified that the UPF performance is improved by approximately 1.4 times.

According to the above-described embodiment of the disclosure, as a GRO algorithm is improved to operate based on a hash table, the performance when more flows are processed is improved compared to the conventional GRO algorithm of the linear search method. This is because the hash table-based GRO algorithm has a time complexity of O(n), which is proportional to the total number of packets regardless of the total number of flows, compared to the conventional GRO algorithm had a time complexity proportional to the total number of flows and the total number of packets. According to an experiment result, when the UPF operates using one CPU core, it is identified that the performance of the UPF using the hash table-based GRO is improved about 1.2 times compared to the performance of the UPF using the conventional linear search-based GRO.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. It will be apparent to those skilled in the art that, in addition to the embodiments set forth herein, other variants based on the technical idea of the disclosure may be implemented.

1. A method performed by a user plane function (UPF) in a wireless communication system, the method comprising:
receiving multiple first size packets from a packet data network (PDN);
merging and converting at least some of the multiple first size packets, received from the PDN, into second size packets;
performing lookup on packet processing rules for one or more of the second size packets and performing packet processing according to a result of the lookup;
dividing the packet-processed second size packets into multiple third size packets; and
transmitting the third size packets to a user terminal.

2. The method of claim 1, wherein the merging and converting of the at least some of the multiple first size packets into second size packets comprises performing primary merging for first packets through a large receive offload (LRO) function corresponding to a hardware function of the UPF, and performing secondary merging for the first packets through a generic receive offload (GRO) function corresponding to a software function of the UPF.

3. The method of claim 2, wherein an algorithm for the GRO function comprises searching for a flow to which packets to be merged belong through a 5-tuple-based hash table.

4. The method of claim 2, wherein an algorithm for the GRO function comprises determining a bucket where a flow to which packets to be merged belong exists through a receive-side scaling (RSS) hash value.

5. The method of claim 1, further comprising:
based on a maximum number of RX queues supported by the UPF, allocating multiple RX queues to at least some CPU cores among CPU cores of the UPF; and
distributing flows, received from the PDN, to the multiple RX queues.

6. The method of claim 1, wherein the first size packets are configured to have a 1500-byte size, and the third size packets are configured to have a 9000-byte size.

7. The method of claim 6, further comprising:
modifying a TCP maximum segment size (MSS) value of a TCP synchronization (SYN) packet, transmitted from the terminal to the PDN, as an MTU value of the PDN; and
modifying a TCP MSS value of a TCP SYN packet, transmitted from the PDN to the terminal, as an MTU value of the terminal.

8. A user plane function (UPF) operating in a wireless communication system, the UPF comprising:
a transceiver; and
a controller,
wherein the controller is configured to:
receive multiple first size packets from a packet data network (PDN);
merge and convert at least some of the multiple first size packets, received from the PDN, into second size packets;
perform lookup on packet processing rules for one or more of the second size packets and perform packet processing according to a result of the lookup;
divide the packet-processed second size packets into multiple third size packets; and
transmit the third size packets to a user terminal.

9. The UPF of claim 8, wherein the controller is further configured to, in the merging and converting of the at least some of the multiple first size packets into second size packets, perform primary merging for first packets through a large receive offload (LRO) function corresponding to a hardware function of the UPF, and perform secondary merging for the first packets through a generic receive offload (GRO) function corresponding to a software function of the UPF.

10. The UPF of claim 9, wherein an algorithm for the GRO function comprise searching for a flow to which packets to be merged belong through a 5-tuple-based hash table.

11. The UPF of claim 9, wherein an algorithm for the GRO function comprises determining a bucket where a flow to which packets to be merged belong exists through a receive-side scaling (RSS) hash value.

12. The UPF of claim 8, wherein the controller is further configured to:
based on a maximum number of RX queues supported by the UPF, allocate multiple RX queues to at least some CPU cores among CPU cores of the UPF; and
distribute flows, received from the PDN, to the multiple RX queues.

13. The UPF of claim 8, wherein the first size packets are configured to have a 1500-byte size, and the third size packets are configured to have a 9000-byte size.

14. The UPF of claim 13, wherein the controller is further configured to:
modify a TCP maximum segment size (MSS) value of a TCP synchronization (SYN) packet, transmitted from the terminal to the PDN, as an MTU value of the PDN; and
modify a TCP MSS value of a TCP SYN packet, transmitted from the PDN to the terminal, as an MTU value of the terminal.
